(19) United States
(12) Patent Application Publication
(10) Pub. No.: US 2006/0132565 A1
(43) Pub. Date: Jun. 22, 2006

(54) Mixtures of anionic and cationic inks

(75) Inventors: Richard P. Szajewski, Rochester, NY (US); Xiaoru Wang, Webster, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/016,375

(22) Filed: Dec. 16, 2004

(51) Int. Cl. G01D 11/00

(52) U.S. Cl. 347/100

(57) ABSTRACT

This invention relates to an ink jet ink set comprising a commonly colored first aqueous ink and second aqueous ink, wherein the first ink has a cationic coloring agent and the second ink has an anionic coloring agent. It further provides a method of printing said inks.

### FIELD OF THE INVENTION

This invention relates to ink jet printing and particularly to mixtures of differently charged inks having a common color to enable the formation of high and consistent density independent of the media employed.

### BACKGROUND OF THE INVENTION

Ink jet printing is a non-impact method for producing images by the deposition of ink droplets in a pixel-by-pixel manner to an image-recording element in response to digital signals. There are various methods that may be utilized to control the deposition of ink droplets on the image-recording element to yield the desired image. In one process, known as continuous inkjet printing, a continuous stream of droplets is charged and deflected in an imagewise manner onto the surface of the image-recording element, while unused droplets are caught and returned to an ink sump. In another process, known as drop-on-demand ink jet printing, individual ink droplets are projected as needed onto the image-recording element to form the desired image. Common methods of controlling the projection of ink droplets in drop-on-demand printing include piezoelectric transducers and thermal bubble formation. Ink jet printers have found broad applications across markets ranging from industrial labeling to short run printing to desktop document and pictorial imaging.

The inks used in the various inkjet printers can be classified as either dye-based or pigment-based. A dye is a colorant which is dissolved in the carrier medium. A pigment is a colorant that is insoluble in the carrier medium, but is dispersed or suspended in the form of small particles, often stabilized against flocculation and settling by the use of dispersing agents. The carrier medium can be a liquid or a solid at room temperature in both cases. Commonly used carrier media include water, mixtures of water and organic co-solvents and high boiling organic solvents, such as hydrocarbons, esters, ketones, etc. Bishop and Czekai in U.S. Pat. No. 5,679,138 describe the preparation and use of micro-milled pigments and carbons employing anionic dispersing agents. These micro-milled pigments are particularly useful in ink-jet printing because of their small particle size. Only anionic charge stabilized pigments are described. More recently, the preparation of covalently functionalized (self-dispersed) pigments and carbons suitable for ink jet printing have been described, inter alia, by Belmont in U.S. Pat. No. 5,554,739, Adams and Belmont in U.S. Pat. No. 5,707,432, Johnson and Belmont in U.S. Pat. Nos. 5,803,959 and 5,922,118 and in published applications WO 96/18695, WO 96/18696, WO 96/18689, WO 99/51690, WO 00/05313, and WO 01/51566. These publications further describe the preparation and use of ink-jet inks employing the described self-dispersed pigments. Both anionic and cationic self-dispersed pigments are described. Takada et al in U.S. 2002/0059883 described the advantages of further stabilizing cationic self-dispersed pigments with acid components. House and Wang et al (EK Dockets in preparation) have more recently described the preparation of polymeric dispersed pigments employing BmE (2-methylpropenoic acid phenylmethyl ester, 2-methylpropenoic acid copolymers) as dispersing agents. The preparation and use of ink-jet inks based on these anionic polymer stabilized pigments are disclosed therein. Needless to say, only anionic charge stabilized pigments are described. Miyabayashi, in U.S. 2002/0077385 describes employing distinct colored inks, each ink employing differently colored anionic polymer stabilized coloring materials or cationic polymer stabilized coloring materials in distinct ink-jet printing channels to control inter-color bleed. Katsuragi et al., in EP 1090966 and Kashiwazaki et al., in U.S. Pat. No. 6,399,674 describe employing distinct colored inks, each ink employing differently colored anionic polymer stabilized coloring materials, anionic dyes or cationic polymer stabilized coloring materials or cationic dyes in distinct ink-jet printing channels to control inter-color bleed. Earlier, Pearlstine et al. in U.S. Pat. No. 5,518,534, Looman in U.S. Pat. No. 5,679,143, Shields and Radke in U.S. Pat. No. 5,428,383 and U.S. Pat. No. 5,488,402, Wang in U.S. Pat. No. 5,772,742 and Gundlach et al., in U.S. Pat. No. 6,039,793 described approaches to control color bleed between image regions having distinct colored inks applied, by pH adjustment or addition of multivalent metallic ions to individual colored inkjet inks.

While these approaches appear to improve the inter-color bleed problem, the formation of high, uniform and consistent single color densities on a variety of plain papers, as well as designed ink-jet papers, have not been adequately addressed. There remains a need for inks meeting these requirements.

### SUMMARY OF THE INVENTION

This invention provides an ink jet ink set comprising a commonly colored first aqueous ink and second aqueous ink, wherein the first ink has a cationic coloring agent and the second ink has an anionic coloring agent and wherein the coloring agents of both the first and second inks comprise pigments. It further provides a method of printing an ink jet image comprising separately applying to an ink jet ink receiver commonly colored first and second inks, wherein the first ink has a cationic coloring agent and the second ink has an anionic coloring agent and wherein the coloring agents of both the first and second inks comprise pigments. It also provides an ink jet ink receiver having an image printed thereon, said image comprising a first aqueous ink and second aqueous ink printed in an overlying manner, wherein the first ink has a cationic coloring agent and the second ink has an anionic coloring agent; wherein the coloring agents of both the first and second inks comprise pigments and wherein the coloring agents are in electrostatic association.

This invention provides the formation of high, uniform and consistent single color densities on a variety of plain papers as well as designed ink-jet papers. The densities are achieved by the ink-jet application from distinct channels of commonly colored anionic and cationic charged pigments in substantially an overlaying manner.

### DETAILED DESCRIPTION OF THE INVENTION

The invention provides an ink jet ink set comprising a commonly colored first aqueous ink and second aqueous ink, wherein the first ink has a cationic coloring agent and the second ink has an anionic coloring agent. The coloring agents of both the first and second inks comprise pigments. A pigment is a colorant that is insoluble in the carrier medium, but is dispersed or suspended in the form of small particles, often stabilized against flocculation and settling by the use of dispersing agents. The cationic coloring agent and the anionic coloring agent are commonly colored. By color is meant the predominate spectral characteristic absorption of the coloring agent. Thus a yellow coloring agent has a predominant maximum spectral absorption of between 425 and 500 nm, a magenta coloring agent has a predominant maximum spectral absorption of between 500 and 580 nm, a cyan coloring agent has a predominant maximum spectral absorption of between 580 and 720 nm. A black coloring agent has spectral absorption across the range of 425 to 700 nm with a bandwidth at one-half height extending across that entire range. Black can comprise a mixture of cyan, magenta and yellow coloring agents. Further, intermediate colors such as provided by orange, purple or green coloring agents are specifically contemplated. These intermediate colored pigments can have a single intermediate maximum spectral absorption or multiple maximum spectral absorptions. By commonly colored it is meant that two coloring agents both have predominant maximum spectral absorptions differing by less than 100 nm or both are black. The individual inks useful in the invention can comprise more than one coloring agent provided the coloring agents present in a single ink are not individually anionic and cationic

While the invention is in no way limited by the following theory, the inventor believes the high, uniform and consistent single color density on a variety of plain papers and designed ink-jet media is derived by the mixing of both cationic and anionic charged material on the media. Modem plain papers tend to be anionic in characteristic while historic plain papers and designed ink-jet media tend to be cationic in character. Accordingly, anionic charged ink components will adhere well to historic plain papers and designed ink-jet media while cationic charged ink components will adhere well to modem plain papers. Mixtures of both anionic and cationic charged ink components having the same color will adhere to one another on mixture forming mixed complexes and at least one of the two will adhere well to both plain paper and designed ink-jet media thus binding the formed complexes to the media.

In general, the ink jet ink composition consists of an aqueous vehicle which functions as a carrier, and a coloring agent. Additives and/or co-solvents can be incorporated in order to adjust the ink to attain the desired performance.

The term ‘coloring agent’ as used herein may refer to just a colorant, or it may refer to a colorant in combination with, for example, a dispersant of some kind. The colorants used herein are pigments. The colorant may be any color, but preferably the colorant is cyan, magenta, yellow or black. The coloring agent comprises a pigment (the colorant), which may be self-dispersed, polymer-dispersed or surfactant dispersed. When the pigment is self-dispersed the colorant is also the coloring agent.

Self-dispersed pigment refers to pigments that have been chemically modified with a charge or a polymeric group, wherein the chemical modification aids the pigment in becoming and/or substantially remaining dispersed in a liquid vehicle. When the pigment is a self-dispersing pigment the charging moiety is covalently linked to the pigment. Polymer-dispersed pigment refers to pigments that utilize a polymer or an oligimer dispersant and/or pigments that utilize a polymer or oligimer physical coating to aid the pigment in becoming and/or substantially remaining dispersed in a liquid vehicle. When the coloring agent is a polymer-dispersed pigment, the polymer may provide the anionic or cationic charge. Surfactant-dispersed pigment refers to pigments that utilize a surfactant dispersant to aid the pigment in becoming and/or substantially remaining dispersed in a liquid vehicle. When the coloring agent is a surfactant-dispersed pigment, the surfactant may provide the anionic or cationic charge. It is also possible that both the pigment and the surfactant or polymer are charged, or that the pigment is charged and the polymer or surfactant are not. What is necessary is that the “charge” remain “available” for interaction with other components on mixing i.e. that the charge is not masked. Normally for a polymer- or surfactant-dispersed pigment, the charge would be provided by the polymer or the surfactant.

The pigments may be chosen from a wide range of conventional colored pigments. Preferably, the pigment is a white pigment, a black pigment, a blue pigment, a brown pigment, a cyan pigment, a green pigment, a violet pigment, a magenta pigment, a red pigment, or a yellow pigment, or shades or combinations thereof Suitable classes of colored pigments include, for example, anthraquinones, phthalocyanine blues, phthalocyanine greens, diazos, monoazos, pyranthrones, perylenes, heterocyclic yellows, quinacridones, diketopyrolo-pyroles, and (thio)indigoids. Representative examples of phthalocyanine blues include copper phthalocyanine blue and derivatives thereof (Pigment Blue 15). Representative examples of quinacridones include Pigment Orange 48, Pigment Orange 49, Pigment Red 122, Pigment Red 192, Pigment Red 202, Pigment Red 206, Pigment Red 207, Pigment Red 209, Pigment Violet 19 and Pigment Violet 42. Representative examples of anthraquinones include Pigment Red 43, Pigment Red 194 (Perinone Red), Pigment Red 216 (Brominated Pyanthrone Red) and Pigment Red 226 (Pyranthrone Red). Representative examples of perylenes include Pigment Red 123 (Vermillion), Pigment Red 149 (Scarlet), Pigment Red 179 (Maroon), Pigment Red 190 (Red), Pigment Violet, Pigment Red 189 (Yellow Shade Red) and Pigment Red 224. Representative examples of thioindigoids include Pigment Red 86, Pigment Red 87, Pigment Red 88, Pigment Red 181, Pigment Red 198, Pigment Violet 36, and Pigment Violet 38. Representative examples of heterocyclic yellows include Pigment Yellow 1, Pigment Yellow 3, Pigment Yellow 12, Pigment Yellow 13, Pigment Yellow 14, Pigment Yellow 17, Pigment Yellow 65, Pigment Yellow 73, Pigment Yellow 74, Pigment Yellow 110, Pigment Yellow 117, Pigment Yellow 128, Pigment Yellow 138, and Pigment Yellow 151. A representative example of diketopyrolo-pyroles include Pigment Red 254. Such pigments are commercially available in either powder or press cake form from a number of sources including, BASF Corporation, Engelhard Corporation and Sun Chemical Corporation. Examples of other suitable colored pigments are described in the Colour Index, 3rd edition (The Society of Dyers and Colourists, 1982). Representative examples of black pigments include various carbon blacks (Pigment Black 7) such as channel blacks, furnace blacks and lamp blacks, and include, for example, carbon blacks sold under the Regal.RTM., Black Pearls.RTM., Elftex.RTM., Monarch.RTM., Mogul.RTM., and Vulcan.RTM. trademarks available from Cabot Corporation (such as Black Pearls.RTM. 2000, Black Pearls.RTM. 1400, Black Pearls.RTM. 1300, Black Pearls.RTM. 1100, Black Pearls.RTM. 1000, Black Pearls.RTM. 900, Black Pearls.RTM. 880, Black Pearls.RTM. 800, Black Pearls.RTM. 700, Black Pearls.RTM. L, Elftex.RTM. 8, Monarch.RTM. 1400, Monarch.RTM. 1300, Monarch.RTM. 1100, Monarch.RTM. 1000, Monarch.RTM. 900, Monarch.RTM. 880, Monarch.RTM. 800, Monarch.RTM. 700, Mogul.RTM. L, Regal.RTM. 330, Regal.RTM. 400, Vulcan.RTM. P). Other suitable carbon blacks include, but are not limited to, Printex 40, Printex 80, Printex 300, Printex L, Printex U, Printex V, Special Black 4, Special Black 5, FW200, (the foregoing available from Degussa Corporation), Raven 780, Raven 890, Raven 1020, Raven 1040, Raven 1255, Raven 1500, Raven 5000, Raven 5250 (the foregoing available from Columbian Chemical Corporation) and MA100 and MA440 available from Mitsubishi Chemical Corporation. Preferably the coloring agents are oppositely charged carbon blacks.

Other suitable pigments within the scope of the present invention include carbon products such as graphite, carbon black, vitreous carbon, carbon fibers, activated charcoal, and activated carbon. The carbon may be of the crystalline or amorphous type. Finely divided forms of the above are preferred; also, it is possible to utilize mixtures of different carbons.

Preferred pigments include those that comprise at least one metal that is not a divalent metal. Examples include, but are not limited to, phthalocyanine pigments containing aluminum, zinc, magnesium, or iron.

The pigments will typically have a wide range of BET surface areas, as measured by nitrogen adsorption. Preferably, the pigment has a surface area equal to or greater than 10 m²/g, and more preferably equal to or greater than and 100 m²/g, thereby corresponding to a smaller primary/aggregate particle size. Such surface areas have been found to provide for a more uniform distribution and efficient level of treating agent on the pigment and a higher percent yield of the modified pigment after post processing techniques. If the preferred higher surface area of the pigment (thereby corresponding to a smaller particle size) is not readily available, it is well recognized by those skilled in the art that the pigment may be subjected to conventional size comminution or reduction techniques, such as ball or jet milling, to reduce the pigment to the desired particle size. Preferably the mean pigment particle size is less than 1000 nm, preferably less than 200 nm, and more preferably less than 150 nm. A mean pigment particle size of between 1 and 130 nm is specifically contemplated and mean pigment particle size of between 5 and 100 nm is preferred. It is recognized that especially useful carbon black pigments typically exhibit a mean particle size of between 60 and 130 nm while cyan, magenta and yellow pigments can exhibit a mean particle size of between 1 and 80 nm.

The ink compositions employing self-dispersed pigments used in the present invention include at least one modified pigment having attached at least one organic group. The organic group may vary depending on the vehicle used for the ink composition as well as on the desired ink and print performance properties. This allows for greater flexibility by tailoring the pigment to the specific application.

In one embodiment, the organic group comprises an ionic group, an ionizable group, or a mixture of an ionic group and an ionizable group. An ionic group is either anionic or cationic and is associated with a counterion of the opposite charge including inorganic or organic counterions such as Na⁺, K⁺, Li⁺, NH₄⁺, NR′₄⁺, acetate, NO₃⁻, SO₄⁻², R′SO₃⁻, R′OSO₃⁻, OH⁻, and Cl⁻ where R′ represents hydrogen or an organic group such as a substituted or unsubstituted aryl and/or alkyl group. An ionizable group is one that is capable of forming an ionic group in the medium of use. Thus, in a preferred embodiment, the organic group is an organic ionic group. Organic ionic groups include those described in U.S. Pat. No. 5,698,016, the description of which is fully incorporated herein by reference.

Negatively charged organic ionic groups may be generated from groups having ionizable substituents that can form anions, such as acidic substituents, or may be the anion in the salts of ionizable substituents. Preferably, when the ionizable substituent forms an anion, the ionizable substituent has a pKa of less than 11. The organic ionic group could further be generated from a species having ionizable groups with a pKa of less than 11 and salts of ionizable substituents having a pKa of less than 11. The pKa of the ionizable substituent refers to the pKa of the ionizable substituent as a whole, not just the acidic substituent. More preferably, the pKa is less than 10 and most preferably less than 9.

Representative examples of ionic groups include —COO—, —SO₃⁻, —OSO₃⁻, —HPO₃⁻, —OPO₃⁻², and —PO₃⁻². Representative examples of ionizable groups include —COOH, —SO₃H, —PO₃H₂, —R′SH, —R′OH, and —SO₂ NHCOR′, where R′ represents hydrogen or an organic group such as a substituted or unsubstituted aryl and/or alkyl group. Particularly preferred species are —COO⁻ and —SO₃⁻. Preferably, the organic ionic group is generated from a substituted or unsubstituted carboxyphenyl group or a substituted or unsubstituted sulfophenyl group. Specific organic ionic groups are —C₆H₄CO₂⁻ and —C₆H₄SO₃⁻.

Positively charged organic ionic groups may be generated from protonated amines that are attached to the pigrnent. Preferably, an organic group having an amine substituent has a pKb of less than 5. Positively charged organic ionic group may be quaternary ammonium groups (—NR′₃⁺) and quaternary phosphonium groups (—PR′₃⁺), where R′ represents hydrogen or an organic group such as a substituted or unsubstituted aryl and/or alkyl group. For example, amines may be protonated to form ammonium groups in acidic media. Quaternized cyclic ammonium ions, and quaternized aromatic ammonium ions, can also be used as the organic ionic group. Thus, N-substituted pyridinium species, such as N-methyl-pyridyl, can be used in this regard. Examples of cationic organic groups include, but are not limited to, -3-C₅H₄N(C₂H₅)⁺, -3-C₅H₄N(CH₃)⁺, -3-C₅H₄N(CH₂C₆H₅)⁺, —C₆H₄(NC₅H₅⁺), —C₆H₄COCH₂N(CH₃)₃⁺, —C₆H₄COCH₂(NC₅H₅)⁺, —C₆H₄SO₂NH(C₄H₃N₂H⁺), —C₆H₄NH₃⁺, —C₆H₄NH₂(CH₃)⁺, —C₆H₄NH(CH₃)₂⁺, —C₆H₄N(CH₃)₃⁺, —C₆H₄CH₂NH₃⁺, —C₆H₄CH₂NH₂(CH₃)⁺, —C₆H₄CH₂NH(CH₃)₂⁺, —C₆H₄CH₂N(CH₃)₃⁺, —C₆H₄CH₂CH₂NH₃⁺, —C₆H₄CH₂CH₂NH₂(CH₃)⁺, —C₆H₄CH₂CH₂NH(CH₃)₂⁺ and —C₆H₄CH₂CH₂N(CH₃)₃⁺. Other substituted or unsubstituted arylene or heteroarylene groups can be used in the place of the C₆H₄ groups shown in the structures above. Preferably, the cationic organic group is —N R′₃⁺ wherein R′ is an alkyl group or an aryl group. Another preferred group is —C₅H₄N—R′⁺, wherein R′ is an alkyl group such as a methyl group or a benzyl group.

In another embodiment, the organic group attached to the modified pigments used in the method of the present invention may also be polymeric. The attached polymer groups may be present as individual attached chains or as a coating on the pigment, as is described below.

For example, the organic group attached to the modified pigments may comprise a pigment having attached at least one organic group represented by the formula —X-Sp-[Polymer]R, wherein X, which is directly attached to the pigment, represents an aryl or heteroaryl group or an alkyl group and is substituted with an Sp group, Sp represents a spacer group, the group Polymer represents a polymeric group comprising repeating monomer groups or multiple monomer groups or both, and R represents hydrogen, a bond, a substituted or unsubstituted alkyl group, or a substituted or unsubstituted aryl group. The group Polymer can be substituted or unsubstituted with additional groups. The total number of monomer repeating units that comprise the “polymer” is not greater than about 500 monomer repeating units.

The group Polymer can be any polymeric group capable of being attached to a pigment. Thus, for example, the group Polymer can be a thermoplastic polymeric group or a thermosetting polymeric group. Further, the polymeric group can be a homopolymer, copolymer, terpolymer, and/or a polymer containing any number of different repeating units. Further, the group Polymer can be any type of polymeric group, such as a random polymer, alternating polymer, graft polymer, block polymer, star-like polymer, and/or comb-like polymer. The group Polymer can also be one or more polyblends. The group Polymer can be an interpenetrating polymer network (IPN); simultaneous interpenetrating polymer network (SIN); or interpenetrating elastomeric network (IEN).

For the group Polymer, examples include, but are not limited to, linear-high polymers such as polyethylene, poly(vinylchloride), polyisobutylene, polystyrene, polycaprolactam (nylon), polyisoprene, and the like. Other general classes are polyamides, polycarbonates, polyelectrolytes, polyesters, polyethers, (polyhydroxy)benzenes, polyimides, -polymers containing sulfur (such as polysulfides, (polyphenylene) sulfide, and polysulfones), polyolefins, polymethylbenzenes, polystyrene and styrene copolymers (ABS included), acetal polymers, acrylic polymers, acrylonitrile polymers and copolymers, polyolefins containing halogen (such as polyvinyl chloride and polyvinylidene chloride), fluoropolymers, ionomeric polymers, polymers containing ketone group(s), liquid crystal polymers, polyamide-imides, polymers containing olefinic double bond(s) (such as polybutadiene and polydicyclopentadiene), polyolefin copolymers, polyphenylene oxides, poly(vinyl alcohols), polyurethanes, thermoplastic elastomers, and the like. Preferably at least some of these monomer units of the group Polymer comprise an ionic group, an ionizable group, or a mixture of ionic or ionizable groups. Additional examples thereof may include those obtained by polymerization of a vinyl monomer and having a cationic nature in at least a part of the resulting polymer. Examples of a cationic monomer for forming the cationic moiety include salts of such tertiary amine monomers as described below, and quatemized product thereof. Namely, there are mentioned: N,N-dimethylaminoethyl methacrylate, N,N-dimethyl-aminoethyl acrylate, N,N-dimethylaminopropyl methacrylate, N,N-dimethylaminopropyl acrylate, N,N-dimethylacrylamide, N,N-dimethylmethacrylamide, N,N-dimethylaminoethylacrylamide, N,N-dimethylaminoethylmethacrylamide, N,N-dimethylaminopropylacrylamide, and N,N-dimethylaminopropyl-methacrylamide. In the case of a tertiary amine, examples of a compound for forming a salt include hydrochloric acid, sulfuric acid and acetic acid. Examples of a compound used in quaternization include methyl chloride, dimethylsulfuric acid, benzyl chloride and epichlorohydrin. Among these, methyl chloride and dimethylsulfuric acid are preferred for preparing a dispersing agent used in the present invention. Such tertiary amine salts or quaternary ammonium compounds as described above behave as a cation in water, and under neutralized conditions, they are stably soluble in an acidic region. The content of these monomers in the copolymer is preferably within a range of from 20 to 60% by weight. Examples of other monomers used in the formation of the above-described high-molecular dispersing agents include hydrophobic monomers, for example, acrylic esters having a hydroxyl group, such as 2-hydroxyethyl methacrylate; and acrylic esters having a side chain of long ethylene oxide chain; and styrene monomers, and water-soluble monomers soluble in water at a pH of about 3 to 10, such as acrylamides, vinyl ethers, vinylpyrrolidones, vinylpyridines and vinyloxazolidines. As the hydrophobic monomers, styrene, styrene derivatives, vinylnaphthalene, vinylnaphthalene derivatives, (meth)acrylic acid alkyl esters and acrylonitrile can be used. In the high-molecular dispersing agent obtained by the copolymerization, the water-soluble monomer be used in the range of from 15 to 35% by weight for the stability of the copolymer in an aqueous solution, and the hydrophobic monomer be used in the range of from 20 to 40% by weight for enhancing the dispersing effect of the copolymer to the pigment.

The group Sp represents a spacer group as described above. A spacer group, as used herein, is a link between two groups and can be a bond, or a chemical group such as, but not limited to, esters such as —CO₂— and —O₂C—, sulfones such as —SO₂— and —SO₂C₂H₄—, ketones such as —C(O)—, amide derivatives such as —NRC(O)—, —C(O)NR—, —NRCO₂—, —O₂CNR—, and —NRC(O)NR—, sulfonates, sulfonamides, —O—, —S—, amines such as —NR, imides, arylene groups, alkylene groups, and the like, wherein R, which can be the same or different, represents hydrogen or an organic group such as a substituted or unsubstituted aryl and/or alkyl group.

The group X represents an aryl or heteroaryl group or an alkyl group. X is directly attached to the pigment and is further substituted with an Sp group. The aromatic group can be further substituted with any group, such as one or more alkyl groups or aryl groups. Preferably, the aryl or heteroaryl group is phenyl, naphthyl, anthracenyl, phenanthrenyl, or biphenyl, and the heteroaryl group is pyridinyl, benzothiadiazolyl, or benzothiazolyl. When X represents an alkyl group, examples include, but are not limited to, substituted or unsubstituted alkyl groups which may be branched or unbranched. The alkyl group can be substituted with one or more groups, such as aromatic groups. Preferred examples include, but are not limited to, C₁-C₁₂ groups like methyl, ethyl, propyl, butyl, pentyl, or hexyl groups. Preferably, X is an aryl group.

The group X may be substituted with one or more functional groups. Examples of functional groups include, but are not limited to, R′″, OR′″, COR′″, COOR′″, OCOR′″, carboxylates, halogens, CN, NR′″₂, SO₃H, sulfonates, sulfates, NR′″(COR′″), CONR′″₂, NO₂, PO₃H₂, phosphonates, phosphates, N═NR′″, SOR′″, NSO₂R′″, wherein R′″ which can be the same or different, is independently hydrogen, branched or unbranched C₁-C₂₀ substituted or unsubstituted, saturated or unsaturated hydrocarbons, e.g., alkyl, alkenyl, alkynyl, substituted or unsubstituted aryl, substituted or unsubstituted heteroaryl, substituted or unsubstituted alkaryl, or substituted or unsubstituted aralkyl.

As shown by the structures above, the group Polymer is attached to the pigment through the spacer group Sp. However, it will also be recognized that when R represents a bond, the available bond can also be attached to the pigment. In addition, the group Polymer can also be attached to the pigment at multiple points along the polymer chain through proper choice of substituent groups on the repeating monomer units. These substituents may also comprise spacer groups or —X-Sp-groups as described above. Thus, these groups can be attached to the pigment at either end or at points along the backbone. Further, these groups can be any type of polymeric group, such as a random polymer, alternating polymer, graft polymer, block polymer, star-like polymer, and/or comb-like polymer.

As another example, the polymer group attached to the pigment can also be directly attached. Thus, the polymer can be attached either through a covalent or ionic bond. The amount of polymer present on the modified pigments can be high enough to cover a substantial amount of the pigment. Thus, in another embodiment, the modified pigment products used in the method of the present invention comprise a pigment that is at least partially coated with one or more polymeric coatings and can be substantially or fully coated by one or more polymers. The use of the term “coated” includes both partially and fully coated pigments and modified pigments-the polymer partially or fully encapsulates the modified pigment, wherein the modified pigment is the core and the polymer is the shell. The polymer(s) coated onto or used to encapsulate the modified pigment is preferably present on the modified pigment such that the polymer(s) is not substantially extractable by an organic solvent. More preferably, the polymer(s) on the modified pigment is attached by physical (for example, adsorption) and/or chemical means (for example, bonding or grafting.

Further details concerning the polymer coated pigments and methods of making them are set forth in International Published Application No. WO 00/22051, incorporated in its entirety by reference herein.

In another preferred embodiment, the attached organic group is a dye. These attached dye organic groups are similar to those that are traditionally used as colorants in ink compositions. Attached dyes include, but are not limited to, food dyes, FD&C dyes, derivatives of phthalocyanine tetrasulfonic acids, including copper phthalocyanine derivates, tetra sodium salts, tetra ammonium salts, tetra potassium salts, tetra lithium salts, and the like. Attached dyes can, for example, provide the ability to modify color balance and adjust optical density while at the same time maintaining and/or providing pigment stability. These organic groups can also be used as an elemental tag for determining either the authenticity or the date of creation of an image, which will be discussed in more detail below.

The amount of attached organic groups, whether ionic, ionizable, or polymeric, employed with charged pigments useful in the present invention can be varied in order to attain desired performance attributes, such as dispersibility in the ink vehicle and print waterfastness and smearfastness. In addition, modified pigment products comprising multiple attached organic groups can result in improved properties. In general, the amount of attached organic groups is from about 0.01 to about 10.0 micromoles of organic group per m² surface area of pigment, as measured by nitrogen adsorption (BET method). For example, the amount of attached organic groups is between from about 0.5 to about 4.0 micromoles per m².

The modified pigments used in the method of the present invention are modified using methods known to those skilled in the art such that organic groups are attached to the pigment. This provides a more stable attachment of the groups onto the pigment compared to adsorbed groups, such as polymers, surfactants, and the like. For example, the modified pigments used in the method of the present invention can be prepared using the methods described in U.S. Pat. Nos. 5,554,739; 5,851,280; 6,042,643; 5,707,432; and 5,837,045, and PCT Publication WO 99/23174, the descriptions of which are fully incorporated herein by reference.

The modified pigments can be purified by washing, such as by filtration, centrifugation, or a combination of the two methods, to remove unreacted raw materials, byproduct salts and other reaction impurities. The products may also be isolated, for example, by evaporation or it may be recovered by filtration and drying using known techniques to those skilled in the art. Dispersions of the pigments may be further purified or classified to remove impurities and other undesirable free species that can co-exist in the dispersion as a result of the manufacturing process. For example, the dispersion can be purified to remove any undesired free species, such as unreacted treating agent. Known techniques of ultrafiltration/diafiltration using a membrane or ion exchange may be used to purify the dispersion and remove a substantial amount of free ionic and unwanted species. An optional exchange of counterions step may also occur in the purification process whereby the counterions that form a part of the modified pigment are exchanged or substituted with alternative counterions (including, e.g., amphiphilic ions) utilizing known ion exchange techniques such as ultrafiltration, reverse osmosis, ion exchange columns and the like. Particular examples of counterions that can be exchanged include, but are not limited to, Na⁺, K⁺, Li⁺, NH₄⁺, Ca⁺², Mg⁺², Cl⁻, NO₃⁻, NO₂⁻, acetate, and Br⁻.

The ink compositions can be formed with a minimum of additional components (additives and/or cosolvents) and processing steps. The modified pigment is present in the ink compositions in an amount effective to provide the desired image qualities (for example, optical density) without detrimentally affecting the performance of the ink. For example, typically, the modified pigment will be present in an amount ranging from about 1% to about 20% based on the weight of the ink. It is also within the bounds of the present invention to use a formulation containing a mixture of unmodified pigments with the modified pigments described above.

The ink compositions can be further purified and/or classified using methods such as those described above for the modified pigments and dispersions thereof. An optional counterion exchange step can also be used. In this way, unwanted impurities or undesirable large particles can be removed to produce an ink with good overall properties.

Polymeric dispersed pigments useful in the present invention can employ the same or similar charged polymeric materials as described above. Here the charged polymers are employed as a dispersing agent for pigment. Any water-soluble or water dispersible resin may be used so far as it can disperse a pigment stably in water or an aqueous medium by the action of an anionic or cationic group. However, those having a weight average molecular weight ranging from 1,000 to 30,000, more preferably from 3,000 to 15,000 are particularly preferred. Specific examples of such water-soluble or water dispersible resins include block copolymers, graft copolymers and random copolymers composed of at least two monomers selected from hydrophobic monomers such as styrene, styrene derivatives, vinylnaphthalene, vinylnaphthalene derivatives and aliphatic alcohol esters of .alpha.,.beta.-ethylenically unsaturated carboxylic acids, and hydrophilic monomers such as acrylic acid and derivatives thereof, maleic acid and derivatives thereof, itaconic acid and derivatives thereof, and fumaric acid and derivatives thereof, and salts of these copolymers. These resins are alkali-soluble resins that dissolve in an aqueous solution of a base.

Homo-polymers composed of a hydrophilic monomer, or salts thereof may also be used. Further, water-soluble resins such as polyvinyl alcohol, carboxymethyl cellulose and condensates of naphthalenesulfonic acid and formaldehyde may also be used. However, use of an alkali-soluble resin has a merit that the viscosity of the resulting dispersion becomes lower, and dispersing operation easier. These water-soluble resins are preferably used within a range of from 0.1 to 5% by weight based on the total weight of the ink.

The polymer-dispersed pigment inks used in the present invention are prepared by dispersing or dissolving such pigment and water-soluble/dispersible resin as described above in an aqueous medium. The aqueous medium preferably used in the pigment inks is a mixed solvent of water and a water-soluble organic solvent. As the water, it is preferable to use ion-exchanged water (deionized water) instead of tap water containing various ions.

Surfactant dispersed pigments employ low molecular weight surface-active agents as dispersants. Any charged low molecular weight surface active agent known in the art can be employed to disperse pigments in a manner useful in the practice of the invention. Specific examples of low molecular weight surface active agent include but are not limited to disodium lauryl sulfosuccinate, disodium polyoxyethylene lauroyl ethanolamide ester sulfosucciate, disodium polyoxyethylene alkyl sulfosuccinate, carboxylated polyoxyethylene laurylether sodium salt, carboxylated polyoxyethylene tridecylether sodium salt, sodium polyoxyethylene laurylether sulfate, polyoxyethylene laurylether sulfate triethanolamine, sodium polyoxyethylene alkylether sulfate, sodium alkyl sulfate, alkyl sulfuric acid triethanolamine, cetyl trimethyl ammonium bromide and so forth.. The used amount of such an anionic or cationic charged substance as described above is preferably within a range of from 0.05 to 10% by weight, more preferably from 0.05 to 5% by weight based on the total weight of the ink.

Any ordinary dispersing apparatus may be employed to prepare the pigment ink. Examples thereof include ball mills, sand mills, etc. Of these mills, a high-speed sand mill may preferably be used, such as Super Mill, Sand Grinder, Beads Mill, Agitator Mill, Grain Mill, Dyno Mill, Pearl Mill and Coball Mill (all are trade names).

In addition, if necessary, additives, such as water-soluble organic solvents, humectants, surface active agents, pH adjusting agents, rust preventives, fungicides, antioxidants, evaporation accelerators, chelating agents, defoamers, buffering agents, conductivity enhancing agents, anti-kogation agents, drying agents, waterfast agents, light stabilizers, or ozone stabilizers, and water-soluble polymers other than the above described components, may be added into inks used in the present invention.

Any water soluble organic solvents or humectants known in the ink are can be employed in the inks useful in the present invention. Examples used herein include amides such as dimethylformamide and dimethylacetamide; ketones such as acetone; ethers such as tetrahydrofuran and dioxane; polyalkylene glycols such as polyethylene glycol and polypropylene glycol; alkylene glycols such as ethylene glycol, propylene glycol, butylene glycol, triethylene glycol, 1,2,6-hexanetriol, thiodiglycol, hexylene glycol and diethylene glycol; lower alkyl ethers of polyhydric alcohols, such as ethylene glycol methyl ether, diethylene glycol monomethyl ether and triethylene glycol monomethyl ether; monohydric alcohols such as methyl alcohol, ethyl alcohol, n-propyl alcohol, isopropyl alcohol, n-butyl alcohol, sec-butyl alcohol, tert-butyl alcohol, and lower alkyl ethers of polyhydric alcohol, such as, glycerine, ethylene glycol monomethyl (or ethyl) ether, diethylene glycol monomethyl (or ethyl) ether, etc.; glycerol, cyclic amide compounds, such as, N-methyl-2-pyrrolidone, 1,3-dimethyl-2-imidazoridinone, sulfolane, dimethyl sulfo oxide, 2-pyrolidone, epsilon caprolactam, etc.; and imido compounds, such as succinimide etc., triethanolamine, sulfolane and dimethyl sulfoxide. No particular limitation is imposed on the content of the water-soluble organic solvent. However, it is preferably within a range of from 5 to 60%, more preferably from 5 to 40% based on the total weight of the liquid composition. Moreover, when a range of 30 to 95 weight % is adopted as a content of water in ink, good solubility of a coloring material is acquired, increase in viscosity of ink is suppressed, and fixing characteristics can fully be satisfied.

The selection of the surfactants is particularly important from the viewpoint of controlling the penetrability of the liquid composition into a recording medium. Examples of the surfactant include anionic surfactants such as fatty acid salts, salts of higher alcohol sulfuric esters, salts of liquid fatty oil sulfuric esters and alkylarylsulfonic acid salts; and nonionic surfactants such as polyoxyethylene alkyl ethers, polyoxyethylene alkyl esters, polyoxyethylene sorbitan alkyl esters, acetylene alcohol and acetylene glycol. One or more of these surfactants may be suitable chosen for use. The amount of the surfactant used varies according to the kind of the dispersing agent used, but is desirably within a range of from 0.01 to 5% by weight based on the total weight of the ink. It is preferred that the amount of the surfactant added be determined in such a manner that the surface tension of the resulting ink is at least 20 mN/m (dyne/cm), because the occurrence of deformed printing (inaccurate ink landing) due to wetting of an orifice can be effectively prevented in an ink-jet recording system used in the present invention. Preferable physical properties of the liquid composition as described above are, the surface tension in a range of from 10 to 70 mN/m (dyn/cm), preferably 20 to 60 mN/m (dyn/cm), and the viscosity in a range of from 1 to 30 centipoise (cP). Inks comprising cationic charged pigments can be adjusted to a pH of between 2 and 7 and preferably between 3 and 5, while inks comprising anionic charged pigments can be adjusted to a pH of between 7 and 11 and preferably between 8 and 10.

The binder resins may be used in combination within a limit not impeding the texture of the recording medium used and the storage stability and ejection stability of the liquid composition, for example, to further improve the rub-off resistance of the cationic fine particles, and may be freely selected from water-soluble polymers, emulsions, latexes, and so forth as known in the art.

The ink jet ink composition is applied using an ink jet printhead. Any type of printhead may be used including, but not limited to, drop-on-demand printheads which utilize piezoelectric transducers or thermal bubble formation, or continuous printheads which utilize electrostatic charging devices and deflector plates. The invention is particularly suitable for use with a thermal printhead. Examples of printheads useful in the invention include those used in Canon USA, Inc., Hewlett-Packard Co., and Epson America Inc. desktop and wide-format ink jet printers, and in printing systems described in U.S. 2004/0100542 A1; U.S. 2003/0117465 A1; U.S. 2003/0043223 A1; U.S. Pat. No. 6,079,821; U.S. Pat. No. 6,450,619 B1; U.S. Pat. No. 6,217,163 B1; U.S. 2004/0032473 A1, U.S. 2003/0189626 A1, or U.S. 2004/0017406 A1. The printhead used in the invention may be part of any type of conventional inkjet printing system that deposits one or more inks or fluids onto an recording element.

The ink compositions of the invention can be applied to various recording elements well known in the art of ink jet printing including both porous and swellable types, and either may be used to generate the printed image. Representative examples of such recording elements are disclosed in U.S. Pat. Nos. 6,045,917; 5,605,750; 5,723,211; 5,789,070 and EP 813 978 A1. In one preferred embodiment the ink jet receiver is plain paper.

The invention also comprises a method of printing an ink jet image comprising separately applying to an ink jet ink receiver commonly colored first and second inks, wherein the first ink has a cationic coloring agent and the second ink has an anionic coloring agent. The inks are as described in detail above. In one embodiment the inks are applied simultaneously in substantially an overlaying manner. In another embodiment the first ink is applied and subsequently the second ink is applied in an overlaying manner; or the second ink is applied and subsequently the first ink is applied in an overlaying manner. By overlying manner, it is meant that the two inks are applied to the media at closely enough to be in reactive association thereby enabling electrostatic cross reaction between the distinctly charged particles in the two distinct inks. In a preferred embodiment each of the first and second ink would have a dedicated delivery channel to avoid having the oppositely charged materials in the two inks interact until they come in reactive association on the intended media.

This invention fuirther comprises an ink jet ink receiver having an image printed thereon, said image comprising a first aqueous ink and second aqueous ink printed in an overlying manner, wherein the first ink has a cationic coloring agent and the second ink has an anionic coloring agent and wherein the coloring agents are electrostatically associated.

The following example is provided to illustrate, but not to limit, the invention.

### EXAMPLES

### Example 1

### Preparation of Black Ink-Jet Ink Samples 1 through 7.

Ink-jet Ink 1 (black dye) was prepared by mixing about 2.3% by weigh isopropyl alcohol, 10.3% urea, 4.9% glycerol, 3.6% ethylene glycol, 6.5% diethylene glycol, and 4% Intrajet Liquid Black 2 with about 0.1% Surfynol-465 surfactant and the balance water at pH˜9.7

Ink-jet Ink 2 (anionic conventionally dispersed) was prepared by mixing about 2.15% of anionic surfactant stabilized carbon black (from a 12% dispersion of OMT [potassium N-methyl-N-oleoyl taurate] dispersed carbon black (PK7) micro-milled according to Bishop and Czekai, U.S. Pat. No. 5,679,138 to an average particle size of about 50 nm), with 12% diethylene glycol, 3% diethylene glycol mono-butyl ether, 1.1% IJ4655 (Truedot) and 0.06% triethanol amine with the balance water at pH˜8.3.

Ink-jet Ink 3 (anionic self dispersed) was prepared by mixing about 4% of an anionic self-dispersed carbon black (from a 15% dispersion of carboxylate derivatized carbon black (PK7) prepared according to Johnson and Belmont, U.S. Pat. No. 5,922,118 an average particle size of about 130 nm), with 12% diethylene glycol, 0.5% Strodex PK-90 surfactant and 0.06% triethanol amine with the balance water at pH˜8.3.

Ink-jet Ink 4 (anionic polymeric dispersed) was prepared by mixing about 2.5% of an anionic polymer stabilized carbon black (from a 9% dispersion of carbon black (PK7) micro milled to average particle size of about 50 nm, in the presence of a methacrylic acid—benzyl methacrylate copolymer according to Wang and House, U.S. patent application (EK docket 88567)), with 12% diethylene glycol, 0.5% Strodex PK-90 surfactant and 0.06% triethanol amine with the balance water at pH˜8.3.

Ink-jet Ink 5 (anionic polymeric dispersed) was prepared by mixing about 2.5% of an anionic polymer stabilized carbon black (from a 9% dispersion of carbon black (PK7) micro milled to average particle size of about 50 nm, in the presence of a methacrylic acid—benzyl methacrylate copolymer according to Wang and House, U.S. patent application (EK docket 88567)), with 3% diethylene glycol, 2% glycerol, 3% diethylene glycol mono-butyl ether and 0.5% Strodex PK-90 and 0.06% triethanol amine with the balance water at pH˜8.3.

Ink-jet Ink 6 (cationic self dispersed) was prepared by mixing about 4% of a cationic self-dispersed carbon black (from a 10% dispersion of polyethyleneimine derivatized carbon black (PK7) prepared according to Palumbo and Lando in WO 01/51566 A1 at an average particle size of about 130 nm), with 12% diethylene glycol, 0.1% Strodex PK-90 surfactant with the balance water at pH˜5.

Ink-jet Ink 7 (cationic self dispersed) was prepared by mixing about 4% of a cationic self-dispersed carbon black (from a 10% dispersion of polyethyleneimine derivatized carbon black (PK7) prepared according to Palumbo and Lando in WO 01/51566 A1 at an average particle size of about 50 nm), with 12% diethylene glycol, 0.1% Strodex PK-90 surfactant with the balance water at pH˜5.

### Example 2

### Ink Jet Image Formation Using Ink-Jet Inks 1 through 7 Singly and in Combination

Ink-jet Inks 1 through 7 were applied singly and in combination using a thermal ink jet printer (Canon i960) to a variety of commercially available general purpose and ink-jet designed plain papers as well ink-jet formulated photo papers. Both the formed density and the uniformity of the formed density deposits were examined. Ink-paper combinations where non-uniform density deposits formed are described as mottled. The mottle appears to be related both to uneven density formation and instances of specific paper fibers that are not colored by the applied inks or ink combinations. The results are reported in Table II, below.

TABLE I
Density and Quality of Images

| | | | | | | Epson | | | | |
|---|---|---|---|---|---|---|---|---|---|---|
| | | | | | | Premium | | | | |
| | | | | Georgia | | Glossy | | | | |
| | | | HP all | Pacific | Xerox | Photo | | | | |
| abs D50, 2 deg, | | Hammermill | purpose | INK | Xpressions | Paper | | | | |
| ANSI Status A, No | Hammermill | 00326-7 | all | JET | all | ink jet | | | | |
| filter - D(B) density | 0620008 | Copier | purpose | ink jet | purpose | glossy | | | | |
| setting | Copier plain | plain | plain | plain | plain | photo | | Average | Density | |
| Ink feature | paper A | paper B | paper A | paper | paper B | paper | Mottle | Density | COV | |
| Ink-jet Ink 1 | 1.25 | 1.26 | 1.21 | 1.20 | 1.17 | 2.26 | no | 1.39 | 31% | |
| (anionic Black Dye) | | | | | | | | | | |
| only | | | | | | | | | | |
| Ink-jet Ink 2 | 0.80 | 0.78 | 0.84 | 0.79 | 0.85 | 2.05 | High | 1.02 | 50% | |
| anionic Carbon only | | | | | | | | | | |
| Ink-jet Ink 3 | 1.27 | 1.23 | 1.39 | 1.19 | 1.42 | 2.00 | High | 1.42 | 21% | |
| anionic Carbon only | | | | | | | | | | |
| Ink-jet Ink 4 | 0.81 | 0.79 | 0.85 | 0.81 | 0.82 | 2.10 | High | 1.03 | 51% | |
| anionic Carbon only | | | | | | | | | | |
| Ink-jet Ink 5 | 0.83 | 0.81 | 0.86 | 0.83 | 0.85 | 2.16 | High | 1.06 | 51% | |
| anionic Carbon only | | | | | | | | | | |
| Ink-jet Ink 6 | 1.20 | 1.16 | 1.16 | 1.25 | 1.19 | 2.12 | Some | 1.35 | 28% | |
| cationic Carbon only | | | | | | | | | | |
| Ink-jet Ink 7 | 0.99 | 0.99 | 1.00 | 1.01 | 0.99 | 2.21 | Some | 1.20 | 41% | |
| cationic Carbon only | | | | | | | | | | |
| double application | 0.90 | 0.81 | 1.01 | 0.84 | 0.90 | 2.77 | High | 1.21 | 64% | |
| Ink-jet Ink 2 | | | | | | | | | | |
| anionic Carbon only | | | | | | | | | | |
| double application | 1.15 | 1.21 | 1.54 | 1.15 | 1.48 | 2.26 | High | 1.47 | 29% | |
| Ink-jet Ink 3 | | | | | | | | | | |
| anionic Carbon only | | | | | | | | | | |
| Ink-jet Ink 1 plus | 1.20 | 1.18 | 1.22 | 1.15 | 1.13 | 2.58 | High | 1.41 | 41% | |
| Ink Jet Ink 2 | | | | | | | | | | |
| (both anionic | | | | | | | | | | |
| carbons) | | | | | | | | | | |
| Ink-jet Ink 2 | 1.02 | 0.96 | 1.03 | 0.91 | 1.22 | 2.22 | High | 1.23 | 41% | |
| plus Ink Jet Ink 3 | | | | | | | | | | |
| (both anionic | | | | | | | | | | |
| carbons) | | | | | | | | | | |
| Ink-jet Ink 2 | 0.86 | 0.79 | 0.90 | 1.18 | 0.88 | 2.21 | High | 1.14 | 48% | |
| plus Ink Jet Ink 4 | | | | | | | | | | |
| (both anionic | | | | | | | | | | |
| carbons) | | | | | | | | | | |
| Ink-jet Ink 2 | 0.89 | 0.83 | 0.90 | 0.84 | 0.89 | 2.43 | High | 1.13 | 56% | |
| plus Ink Jet Ink 5 | | | | | | | | | | |
| (both anionic | | | | | | | | | | |
| carbons) | | | | | | | | | | |
| Ink-jet Ink 2 | 1.52 | 1.54 | 1.58 | 1.55 | 1.55 | 1.69 | Low | 1.57 | 4% | INV |
| plus Ink Jet Ink 6 | | | | | | | | | | |
| (one anionic and | | | | | | | | | | |
| one cationic carbon) | | | | | | | | | | |
| Ink-jet Ink 2 | 1.37 | 1.38 | 1.63 | 1.90 | 1.34 | 1.65 | Low | 1.55 | 14% | INV |
| plus Ink Jet Ink 7 | | | | | | | | | | |
| (one anionic and | | | | | | | | | | |
| one cationic carbon) | | | | | | | | | | |

As is readily apparent, the combination of both an anionic pigment and a cationic pigment of the same color applied from distinct ink jet application nozzle banks to the same image area provides for the highest density across a wide variety of media, reduced mottle and the smallest variation in formed density between the various media thus improving the consumer ink-jet experience.

### Example 3

### Preparation of Black Ink-Jet Ink Samples 8 through 13.

Ink-jet Ink 8 (cationic self dispersed) was prepared by mixing about 4% of a cationic self-dispersed carbon black (from a 10% dispersion of polyethyleneimine derivatized carbon black (PK7) prepared according to Palumbo and Lando in WO 01/51566 A1 at an average particle size of about 50 nm), with 12% diethylene glycol, 0.5% Surfynol-465 surfactant with the balance water at pH˜5.

Ink-jet Ink 9 (anionic self dispersed) was prepared by mixing about 4% of an anionic self-dispersed carbon black (from a 15% dispersion of carboxylate derivatized carbon black (PK7) prepared according to Johnson and Belmont, U.S. Pat. No. 5,922,118 an average particle size of about 130 nm), with 12% diethylene glycol, 0.5% Surfynol-465 surfactant and 0.06% triethanol amine with the balance water at pH˜8.3.

Ink-jet Ink 10 (anionic self dispersed) was prepared by mixing about 4% of an anionic self-dispersed carbon black (from a 15% dispersion of carboxylate derivatized carbon black (PK7) prepared according to Johnson and Belmont, U.S. Pat. No. 5,922,118 an average particle size of about 130 nm), with 5% diethylene glycol, 2.5% glycerol, 0.5% Surfynol-465 surfactant and 0.06% triethanol amine with the balance water at pH˜8.3.

Ink-jet Ink 11 (anionic conventionally dispersed) was prepared by mixing about 2.15% of anionic surfactant stabilized carbon black (from a 12% dispersion of OMT [potassium N-methyl-N-oleoyl taurate] dispersed carbon black (PK7) micro-milled according to Bishop and Czekai, U.S. Pat. No. 5,679,138 to an average particle size of about 50 nm), with 12% diethylene glycol, 3% glycerol, 1.1% IJ4655 (Truedot) and 0.06% triethanol amine with the balance water at pH˜8.3.

Ink-jet Ink 12 (anionic conventionally dispersed) was prepared by mixing about 2.15% of anionic surfactant stabilized carbon black (from a 12% dispersion of OMT [potassium N-methyl-N-oleoyl taurate] dispersed carbon black (PK7) micro-milled according to Bishop and Czekai, U.S. Pat. No. 5,679,138 to an average particle size of about 50 nm), with 5% diethylene glycol, 2.5% glycerol, 0.5% Strodex-PK90 surfactant, 1.1% IJ4655 (Truedot) and 0.06% triethanol amine with the balance water at pH˜8.3.

Ink-jet Ink 13 (anionic conventionally dispersed) was prepared by mixing about 2.15% of anionic surfactant stabilized carbon black (from a 12% dispersion of OMT [potassium N-methyl-N-oleoyl taurate] dispersed carbon black (PK7) micro-milled according to Bishop and Czekai, U.S. Pat. No. 5,679,138 to an average particle size of about 50 mn), with 5% diethylene glycol, 2.5% glycerol, 0.5% Surfynol-465 surfactant, 1.1% IJ4655 (Truedot) and 0.06% triethanol amine with the balance water at pH˜8.3.

### Example 4

### Ink Jet Image Formation Using Ink-Jet Inks 8 Through 13 Singly and in Combination

Ink-jet Inks 8 through 13 were applied singly and in combination using a thermal ink jet printer (Canon i960) to a variety of commercially available general purpose and ink-jet designed plain papers as well ink-jet formulated photo papers. Both the formed density and the uniformity of the formed density deposits were examined. Ink-paper combinations where non-uniform density deposits formed are described as mottled. The mottle appears to be related both to uneven density formation and instances of specific paper fibers that are not colored by the applied inks or ink combinations. The results are reported in Table II, below.

TABLE II
Density and Quality of Images

| | | | all | | all | | Density | Density |
|---|---|---|---|---|---|---|---|---|
| | Copier | Copier | purpose | ink jet | purpose | | Average | COV |
| | plain | plain | plain | plain | plain | | across | across |
| Ink feature | paper A | paper B | paper A | paper | paper B | | papers | papers |
| Anionic Ink-Jet Ink 3 alone | 1.19 | 1.15 | 1.31 | 1.16 | 1.39 | | 1.24 | 8.5 |
| Cationic Ink-Jet Ink 8 alone | 1.12 | 1.12 | 1.12 | 1.17 | 1.09 | | 1.12 | 2.6 |
| Anionic Ink-Jet Ink 3 and | 1.48 | 1.46 | 1.50 | 1.50 | 1.48 | INV | 1.48 | 1.1 |
| Cationic Ink-Jet Ink 8 together | | | | | | | | |
| Anionic Ink-Jet Ink 9 alone | 1.20 | 1.13 | 1.14 | 0.98 | 1.20 | | 1.13 | 8.0 |
| Anionic Ink-Jet Ink 3 and | 1.26 | 1.13 | 1.14 | 0.92 | 1.45 | | 1.18 | 16.5 |
| Anionic Ink-Jet Ink 9 together | | | | | | | | |
| Anionic Ink-Jet Ink 9 and | 1.56 | 1.52 | 1.55 | 1.53 | 1.53 | INV | 1.54 | 1.1 |
| Cationic Ink-Jet Ink 8 together | | | | | | | | |
| Anionic Ink-Jet Ink 10 alone | 1.16 | 1.10 | 1.11 | 0.96 | 1.14 | | 1.09 | 7.2 |
| Anionic Ink-Jet Ink 3 and | 1.24 | 1.05 | 1.05 | 0.93 | 1.42 | | 1.14 | 16.9 |
| Anionic Ink-Jet Ink 10 together | | | | | | | | |
| Anionic Ink-Jet Ink 10 and | 1.51 | 1.49 | 1.55 | 1.54 | 1.51 | INV | 1.52 | 1.6 |
| Cationic Ink-Jet Ink 8 together | | | | | | | | |
| Anionic Ink-Jet Ink 11 alone | 0.76 | 0.75 | 0.79 | 0.84 | 0.75 | | 0.78 | 4.9 |
| Anionic Ink-Jet Ink 3 and | 0.94 | 0.98 | 1.03 | 0.90 | 1.33 | | 1.04 | 16.5 |
| Anionic Ink-Jet Ink 11 together | | | | | | | | |
| Anionic Ink-Jet Ink 11 and | 1.51 | 1.52 | 1.53 | 1.50 | 1.49 | INV | 1.51 | 1.0 |
| Cationic Ink-Jet Ink 8 together | | | | | | | | |
| Anionic Ink-Jet Ink 12 alone | 0.75 | 0.79 | 0.79 | 0.73 | 0.76 | | 0.76 | 3.4 |
| Anionic Ink-Jet Ink 3 and Anionic | 0.89 | 0.95 | 1.02 | 0.89 | 1.05 | | 0.96 | 7.7 |
| Ink-Jet Ink 12 together | | | | | | | | |
| Anionic Ink-Jet Ink 12 and | 1.46 | 1.47 | 1.52 | 1.48 | 1.49 | INV | 1.48 | 1.6 |
| Cationic Ink-Jet Ink 8 together | | | | | | | | |
| Anionic Ink-Jet Ink 13 alone | 0.72 | 0.76 | 0.77 | 0.74 | 0.74 | | 0.75 | 2.6 |
| Anionic Ink-Jet Ink 3 and | 0.91 | 0.95 | 0.98 | 0.88 | 1.18 | | 0.98 | 12.1 |
| Anionic Ink-Jet Ink 13 together | | | | | | | | |
| Anionic Ink-Jet Ink 13 and | 1.50 | 1.50 | 1.52 | 1.52 | 1.51 | INV | 1.51 | 0.7 |
| Cationic Ink-Jet Ink 8 together | | | | | | | | |
| Double application of | 1.18 | 1.10 | 1.49 | 1.09 | 1.55 | | 1.28 | 17.2 |
| Anionic Ink-Jet Ink 3 | | | | | | | | |

As is readily apparent, the combination of both an anionic pigment and a cationic pigment of the same color applied from distinct ink jet application 5 nozzle banks to the same image area provides for the highest density across a wide variety of media and the smallest variation in formed density between the various media thus improving the consumer ink-jet experience.

### Example 5

### Preparation of Cyan, Magentas Yellow and Black Ink-Jet Ink Samples 14 Through 22

Ink-Jet Ink 14 (cationic conventionally dispersed) was prepared by mixing about 2.5% of a cationic surfactant stabilized cyan pigment (from a micro-milled dispersion of Cetyl-trimethyl ammonium bromide [CTAB] dispersed cyan copper phthalocyanine pigment (See Wang et al EK Docket 88567 not yet filed), with 15% Polyethylene Glycol (Mn ˜300), 6% 2-pyrrolidinone, 0.2% Surfynol-465 with the balance water.

Ink-jet Ink 15 (anionic conventionally dispersed) was prepared by mixing about 2.5% of anionic surfactant stabilized cyan pigment (from a ca. 10% dispersion of OMT [potassium N-methyl-N-oleoyl taurate] dispersed cyan pigment PB15:3 micro-milled according to Bishop and Czekai, U.S. Pat. No. 5,679,138, with 7% diethylene glycol, 3% glycerol, 1.8% IJ4655 (Trudot), 0.1% Surfynol-465 and 0.06% triethanol amine with the balance water at pH˜8.3.

Ink-jet Ink 16 (cationic conventionally dispersed) was prepared by mixing about 3% of a cationic surfactant stabilized magenta pigment (from a micro-milled dispersion of Cetyl-trimethyl ammonium bromide [CTAB] dispersed magenta pigment PR122 (See Wang et al EK Docket 88567 not yet filed), with 15% Polyethylene Glycol (Mn ˜300), 6% 2-pyrrolidinone, 0.2% Surfynol-465 with the balance water.

Ink-jet Ink 17 (anionic conventionally dispersed) was prepared by mixing about 3% of anionic surfactant stabilized magenta pigment (from a ca. 10% dispersion of OMT [potassium N-methyl-N-oleoyl taurate] dispersed magenta pigment PR122 micro-milled according to Bishop and Czekai, U.S. Pat. No. 5,679,138, with 18% diethylene glycol, 5% glycerol, 1.2% IJ4655 (Trudot), 0.5% Surfynol-465 and 0.06% triethanol amine with the balance water at pH˜8.3.

Ink-jet Ink 18 (cationic conventionally dispersed) was prepared by mixing about 3.2% of a cationic surfactant stabilized yellow pigment (from a micro-milled dispersion of Cetyl-trimethyl ammonium bromide [CTAB] dispersed yellow pigment PY74 (See Wang et al EK Docket 88567 not yet filed), with 15% Polyethylene Glycol (Mn ˜300), 6% 2-pyrrolidinone, 0.2% Surfynol-465 with the balance water.

Ink-jet Ink 19 (anionic conventionally dispersed) was prepared by mixing about 3.2% of anionic surfactant stabilized yellow pigment (from a ca. 10% dispersion of OMT [potassium N-methyl-N-oleoyl taurate] dispersed yellow pigment PY155 micro-milled according to Bishop and Czekai, U.S. Pat. No. 5,679,138, with 5% diethylene glycol, 10% glycerol, 1.6% IJ4655 (Trudot), 0.5% Surfynol-465 and 0.06% triethanol amine with the balance water at pH˜8.3.

Ink-jet Ink 20 (cationic conventionally dispersed) was prepared by mixing about 3.2% of a cationic surfactant stabilized yellow pigment (from a micro-milled dispersion of Cetyl-trimethyl ammonium bromide [CTAB] dispersed yellow pigment PY155 (See Wang et al EK Docket 88567 not yet filed), with 15% Polyethylene Glycol (Mn ˜300), 6% 2-pyrrolidinone, 0.2% Surfynol-465 with the balance water.

Ink-jet Ink 21 (cationic conventionally dispersed) was prepared by mixing about 2.2% of a cationic surfactant stabilized carbon black pigment (from a micro-milled dispersion of Cetyl-trimethyl ammonium bromide [CTAB] dispersed carbon black PK7 (See Wang et al EK Docket 88567 not yet filed), with 15% Polyethylene Glycol (Mn ˜300), 6% 2-pyrrolidinone, 0.2% Surfynol-465 with the balance water.

Ink-jet Ink 22 (cationic self dispersed) was prepared by mixing about 4% of an anionic self-dispersed carbon black (from a 15% dispersion of carboxylate derivatized carbon black (PK7) prepared according to Johnson and Belmont, U.S. Pat. No. 5,922,118 an average particle size of about 130 nm), with 25% diethylene glycol, 0.1% Surfynol-465 surfactant and 0.1% triethanol amine with the balance water at pH˜8.3.

Ink-jet Ink 23 (cationic conventionally dispersed) was prepared by mixing about 2.2% of anionic surfactant stabilized carbon black (from a 12% dispersion of OMT [potassium N-methyl-N-oleoyl taurate] dispersed carbon black (PK7) micro-milled according to Bishop and Czekai, U.S. Pat. No. 5,679,138 to an average particle size of about 50 nm), with 25% diethylene glycol, 1% IJ4655 (Trudot), 0.5% Surfynol-465 surfactant and 0.5% triethanol amine with the balance water at pH˜8.3.

Ink-jet Ink 24 (cationic polymeric dispersed) was prepared by mixing about 2.5% of an cationic polymer stabilized carbon black (from a 9% dispersion of carbon black (PK7) micro milled to average particle size of about 50 nm, in the presence of a N, N, N-trimethylethanolammonium methyacrylate—benzyl methacrylate copolymer (See Wang et al EK Docket 88567 not yet filed), with 12% Polyethylene Glycol (Mn ˜400), 9% 2-pyrrolidinone, 0.2% Surfynol-465 with the balance waterat pH˜5.

Ink-jet Ink 25 (cationic conventionally dispersed) was prepared by mixing about 2.2% of anionic surfactant stabilized carbon black (from a 12% dispersion of OMT [potassium N-methyl-N-oleoyl taurate] dispersed carbon black (PK7) micro-milled according to Bishop and Czekai, U.S. Pat. No. 5,679,138 to an average particle size of about 50 nm), with 15% Polyethylene Glycol (Mn ˜300), 6% 2-pyrrolidinone, 0.2% Surfynol-465 with the balance water at pH˜8.3.

Ink-jet Ink 26 (cationic conventionally dispersed) was prepared by mixing about 2.5% of anionic surfactant stabilized cyan pigment (from a ca. 10% dispersion of OMT [potassium N-methyl-N-oleoyl taurate] dispersed cyan pigment PB15:3 micro-milled according to Bishop and Czekai, U.S. Pat. No. 5,679,138, with 15% Polyethylene Glycol (Mn ˜300), 6% 2-pyrrolidinone, 0.2% Surfynol-465 with the balance water at pH˜8.3.

Ink-jet Ink 27 (cationic conventionally dispersed) was prepared by mixing about 3% of anionic surfactant stabilized magenta pigment (from a ca. 10% dispersion of OMT [potassium N-methyl-N-oleoyl taurate] dispersed magenta pigment PR122 micro-milled according to Bishop and Czekai, U.S. Pat. No. 5,679,138, with 15% Polyethylene Glycol (Mn ˜300), 6% 2-pyrrolidinone, 0.2% Surfynol-465 with the balance water at pH˜8.3.

Ink-jet Ink 28 (cationic conventionally dispersed) was prepared by mixing about 3.2% of anionic surfactant stabilized yellow pigment (from a ca. 10% dispersion of OMT [potassium N-methyl-N-oleoyl taurate] dispersed yellow pigment PY155 micro-milled according to Bishop and Czekai, U.S. Pat. No. 5,679,138, with 15% Polyethylene Glycol (Mn ˜300), 6% 2-pyrrolidinone, 0.2% Surfynol-465 with the balance water at pH˜8.3.

### Example 6

### Ink Jet Image Formation Using Ink-Jet Inks 14 Through 28 Singly and in Combination

Ink-jet Inks 14 through 28 were applied singly and in combination using a thermal ink jet printer (Canon i960) to a variety of commercially available general purpose and ink-jet designed plain papers as well ink-jet formulated photo papers. Both the formed density and the uniformity of the formed density deposits across media were investigated. The results are reported in Table III, below.

TABLE II
Density and Quality of Images

| | | | | | Average | Density |
|---|---|---|---|---|---|---|
| | | All | | | Density | COV |
| | Copier | Purpose | Ink Jet | | Across | Across |
| | Plan | Plain | Plain | | Plain | Plain |
| Ink feature | Paper A | Paper A | Paper A | | Papers | Papers |
| Cationic Ink-jet Ink 14 only | 0.87 | 0.90 | 0.82 | | 0.86 | 4.8 |
| Anionic Ink-Jet Ink 15 only | 0.80 | 0.86 | 0.83 | | 0.83 | 3.7 |
| Both Cationic 14 and Anionic15 | 1.10 | 1.09 | 1.00 | INV | 1.06 | 5.4 |
| Cationic Ink-jet Ink 18 only | 0.89 | 0.95 | 0.88 | | 0.91 | 4.0 |
| Anionic Ink-Jet Ink 19 only | 0.81 | 0.82 | 0.76 | | 0.80 | 4.0 |
| Both Cationic 18 and Anionic19 | 0.99 | 1.10 | 1.04 | INV | 1.04 | 5.3 |
| Cationic Ink-jet Ink 20 only | 0.86 | 0.82 | 0.75 | | 0.81 | 6.4 |
| Anionic Ink-Jet Ink 19 only | 0.80 | 0.82 | 0.76 | | 0.79 | 4.0 |
| Both Cationic 20 and Anionic 19 | 1.06 | 1.03 | 0.98 | INV | 1.02 | 4.2 |
| Cationic Ink-jet Ink 21 only | 1.10 | 1.09 | 0.96 | | 1.05 | 7.5 |
| Anionic Ink-jet Ink 22 only | 1.42 | 1.44 | 1.28 | | 1.38 | 6.6 |
| Double application Anionic 22 | 1.48 | 1.50 | 1.36 | | 1.44 | 5.3 |
| Both Cationic 21 and Anionic 22 | 1.46 | 1.45 | 1.43 | INV | 1.45 | 0.9 |
| Cationic Ink-jet Ink 21 only | 1.01 | 1.05 | 0.91 | | 0.99 | 7.3 |
| Anionic Ink-Jet Ink 23 only | 0.86 | 0.87 | 0.81 | | 0.85 | 4.2 |
| Both Cationic 21 and Anionic 23 | 1.31 | 1.29 | 1.27 | INV | 1.29 | 1.7 |
| Cationic Ink-jet Ink 21 only | 0.98 | 1.02 | 0.89 | | 0.96 | 6.8 |
| Cationic Ink-Jet Ink 24 only | 0.94 | 1.03 | 0.99 | | 0.98 | 4.5 |
| Both Cationic 21 and Cationic 24 | 0.98 | 1.09 | 1.03 | | 1.03 | 5.8 |
| Cationic Ink-jet Ink 20 only | 1.11 | 1.10 | 0.97 | | 1.06 | 7.3 |
| Anionic Ink-Jet Ink 25 only | 0.96 | 0.93 | 0.86 | | 0.92 | 5.7 |
| Both Catinoic 20 and Anionic 25 | 1.43 | 1.43 | 1.40 | INV | 1.42 | 1.4 |
| Anionic Ink-jet Ink 26 only | 0.91 | 0.93 | 0.85 | | 0.90 | 4.3 |
| Both Anionic 26 and Anionic 15 | 0.89 | 0.98 | 0.90 | | 0.92 | 5.6 |
| Anionic Ink-jet Ink 27 only | 0.85 | 0.85 | 0.79 | | 0.83 | 4.3 |
| Anionic Ink-Jet Ink 17 only | 0.77 | 0.83 | 0.78 | | 0.79 | 3.7 |
| Both Anionic 27 and Anionic 17 | 0.84 | 0.90 | 0.82 | | 0.85 | 4.6 |
| Anionic Ink-jet Ink 28 only | 0.84 | 0.88 | 0.79 | | 0.84 | 5.1 |
| Both Anionic 28 and Anionic 19 | 0.83 | 0.88 | 0.81 | | 0.84 | 4.0 |

As is readily apparent, the combination of both an anionic pigment and a cationic pigment of the same color applied from distinct ink jet application nozzle banks to the same image area provides for the highest density across a wide variety of media and the smallest variation in formed density between the various media thus improving the consumer ink-jet experience. The data above illustrate that the positive effects illustrated in earlier examples with carbon blacks can also be achieved with cyan, magenta or yellow colored pigments.

### Example 7

### Layout for Printing of Color and Gray Scale Images on a Variety of Media

In an ink-jet printer system accommodating six delivery systems, the individual delivery systems are each charged with Inks employing anionic and cationic materials according to the following scheme:

Text-Black delivery system (Kt)—cationic black colorant

Photo-Black delivery system (Kp)—anionic black colorant having optional anionic filler particles

Cyan delivery system (C)—anionic cyan colorant having optional anionic filler particles

Magenta delivery system (M)—anionic magenta colorant having optional anionic filler particles

Yellow delivery system (Y)—anionic yellow colorant having optional anionic filler particles

The printer head driver will deliver distinct combinations of these inks depending both on the color appropriate for the desired image or text and on user input as to plain paper v photo-paper choice.

Text Black on plain paper—system delivers Kt & Kp

Photo Black on photo paper—system delivers Kp

Cyan, Magenta or Yellow on plain or photo paper—system delivers C, M, or Y

Secondary Colors (i.e. C, M Y mixtures)—system delivers C, M, and Y as appropriate

Process Black on plain paper—system delivers C, M, Y, Kp & Kt

Process Black on photo paper—system delivers C, M, Y, & Kp

The scheme enables the delivery of mixtures of anionic and cationic pigments to black areas of plain papers thus ensuring the formation of uniform densities on a variety of plain papers.

### Example 8

### Layout for Printing of Color and Gray Scale Images on a Variety of Media

In an ink-jet printer system accommodating six delivery systems, the individual delivery systems are each charged with Inks employing anionic and cationic materials according to the following scheme:

Text-Black delivery system (Kt)—cationic black colorant

Photo-Black delivery system (Kp)—anionic black colorant having optional anionic filler particles

Cyan delivery system (C)—anionic cyan colorant having optional anionic filler particles

Magenta delivery system (M)—anionic magenta colorant having optional anionic filler particles

Yellow delivery system (Y)—anionic yellow colorant having optional anionic filler particles

Protective component delivery system (P)—anionic polymeric protective binder

The printer head driver will deliver distinct combinations of these inks depending both on the color appropriate for the desired image or text and on user input as to plain paper v photo-paper choice.

Text Black on plain paper—system delivers Kt & Kp

Photo Black on photo paper—system delivers Kp & P

Cyan, Magenta or Yellow on plain or photo paper—system delivers C, M, or Y & P

Secondary Colors (i.e. C, M Y mixtures)—system delivers C, M, and Y & P as appropriate

Process Black on plain paper—system delivers C, M, Y, Kp & Kt

Process Black on photo paper—system delivers C, M, Y, P & Kp

The scheme enables the delivery of mixtures of anionic and cationic pigments to black areas of plain papers thus ensuring the formation of uniform densities on a variety of plain papers.

### Example 9

### Layout for Printiny of Color and Gray Scale Images on a Variety of Media

In an ink-jet printer system accommodating six delivery systems, the individual delivery systems are each charged with Inks employing anionic and cationic materials according to the following scheme:

Text-Black delivery system (Kt)—anionic black colorant

Cyan delivery system (C)—anionic cyan colorant

Second Cyan delivery system (pC)—cationic cyan colorant

Magenta delivery system (M)—anionic magenta colorant

Second Magenta delivery system (pM)—cationic magenta colorant

Yellow delivery system (Y)—anionic yellow colorant

The printer head driver will deliver distinct combinations of these inks depending both on the color appropriate for the desired image or text and on user input as to plain paper v photo-paper choice.

Text Black on plain paper or Photo Papers—system delivers Kt

Cyan, Magenta or Yellow on photo paper—system delivers C, M, or Y

Secondary Colors on photo paper (i.e. C, M Y mixtures)—system delivers C, M, and Y as appropriate

Process Black on photo paper—system delivers C, M, Y & Kt

Cyan on plain paper—system delivers C and pC

Magenta on plain paper—system delivers M and pM

### Example 10

### Layout for Printing of Color and Gray Scale Images on a Variety of Media

In an ink-jet printer system accommodating eight delivery systems, the individual delivery systems are each charged with Inks employing anionic and cationic materials according to the following scheme:

Text-Black delivery system (Kt)—cationic black colorant

Second Black delivery system (Kp)—anionic black colorant

Cyan delivery system (C)—anionic cyan colorant

Magenta delivery system (M)—anionic magenta colorant

Yellow delivery system (Y)—anionic yellow colorant

Second Cyan delivery system (pC)—cationic cyan colorant

Second Magenta delivery system (pM)—cationic magenta colorant

Second Yellow delivery system (pY)—cationic yellow colorant

The printer head driver will deliver distinct combinations of these inks depending both on the color appropriate for the desired image or text and on user or device driven input as to plain paper v photo-paper choice.

Black on plain paper—system delivers Kt & Kp

Cyan on plain paper—system delivers C and pC

Magenta on plain paper—system delivers M and pM

Yellow on plain paper—system delivers Y and pY.

Cyan, Magenta & Yellow on designed photo paper—system delivers C, M, & Y or pC, pM & pY depending on charge characteristics of designed photo paper.

The scheme enables the delivery of mixtures of anionic and cationic pigments to black and colored areas of plain papers thus ensuring the formation of uniform densities on a variety of plain papers. Any of the described inks can employ optional charged particles to aid in density formation and color retentions all as known in the art.

The invention has been described in detail with particular reference to certain preferred embodiments thereof, but it will be understood that variations and modifications can be effected within the spirit and scope of the invention.

1. An ink jet ink set comprising a commonly colored first aqueous ink and second aqueous ink, wherein the first ink has a cationic coloring agent and the second ink has an anionic coloring agent and wherein the coloring agents of both the first and second inks comprise pigments.

2. The ink jet ink of claim 1 wherein the coloring agents of the first and second inks are black.

3. The ink jet ink of claim 1 wherein the coloring agents of the first and second inks are cyan.

4. The ink jet ink of claim 1 wherein the coloring agents of the first and second inks are magenta.

5. The ink jet ink of claim 1 wherein the coloring agents of the first and second inks are yellow.

6. The ink jet ink of claim 2 wherein the coloring agents of the first and second inks are oppositely charged carbon black.

7. The ink jet ink of claim 1 wherein the coloring agent of either the first or second ink, or both, comprises a colorant that is a polymerically dispersed pigment, wherein said polymer provides the charge.

8. The ink jet ink of claim 1 wherein the coloring agent of either the first or second ink, or both, comprises a colorant that is a surfactant-dispersed pigment, wherein the surfactant provides the charge.

9. The ink jet ink of claim 1 wherein the coloring agent of either the first or second ink, or both, comprises a colorant that is a self-dispersed pigment, wherein the charging moiety is covalently attached to the pigment.

10. The ink jet set of claim 1 comprising a cyan, magenta, yellow and black ink set wherein each of the cyan, magenta, yellow and black ink sets comprises a commonly colored first aqueous ink and second aqueous ink, wherein the first ink has a cationic coloring agent and the second ink has an anionic coloring agent.

11. A method of printing an ink jet image comprising separately applying to an ink jet ink receiver commonly colored first and second inks, wherein the first ink has a cationic coloring agent and the second ink has an anionic coloring agent and wherein the coloring agents of both the first and second inks comprise pigments.

12. The method of claim 11 wherein the inks are applied simultaneously in substantially an overlaying manner.

13. The method of claim 11 wherein the first ink is applied and subsequently the second ink is applied in an overlaying manner.

14. The method of claim 11 wherein the second ink is applied and subsequently the first ink is applied in an overlaying manner.

15. The method of claim 11 wherein the ink jet receiver is plain paper.

16. An ink jet ink receiver having an image printed thereon, said image comprising a first aqueous ink and second aqueous ink printed in an overlying manner, wherein the first ink has a cationic coloring agent and the second ink has an anionic coloring agent; wherein the coloring agents of both the first and second inks comprise pigments; and wherein the coloring agents are electrostatically associated.
